(19) United States
(12) Patent Application Publication
(10) Pub. No.: US 2020/0198983 A1
(43) Pub. Date: Jun. 25, 2020

(54) CZTS PRECURSOR INKS AND METHODS FOR PREPARING CZTS THIN FILMS AND CZTS-BASED-DEVICES

(71) Applicants: The University of Melbourne, Victoria (AU); Monash University, Clayton (AU)

(72) Inventors: Cameron Ritchie, Victoria (AU); Jacek Jasieniak, Clayton (AU); Paul Mulvaney, Victoria (AU)

(21) Appl. No.: 16/721,665

(22) Filed: Dec. 19, 2019

(30) Foreign Application Priority Data
Dec. 21, 2018 (AU) 2018282493

(51) Int. Cl. C01G 19/00; C09D 11/033; C09D 11/38; C09C 3/08

(52) U.S. Cl. CPC C01G 19/006; C09D 11/033; B82Y 40/00; C09C 3/08; C09D 11/38

(57) ABSTRACT

The present disclosure relates to compositions comprising quaternary metal chalcogenide nanoparticles stabilized by an inorganic metal-chalcogenide stabilizing agent, wherein the nanoparticles are dispersible in a polar solvent. More particularly, the disclosure relates to compositions of CZTS nanoparticles. This disclosure provides processes for manufacturing these compositions. The disclosure also provides coated substrates, thin films and devices comprising the compositions, and processes for manufacturing the same.

### CROSS REFERENCE TO RELATED APPLICATIONS

This application claims priority from Australian patent application 2018282493, filed Dec. 21, 2018, the contents of which are incorporated herein by reference for all purposes. The contents of the applicant's co-pending Australian patent application 2018904917 filed on the same date as Australian patent application 2018282493 and entitled “CZTSe precursor inks and methods for preparing CZTS/Se thin films and CZTS/Se-based devices” are incorporated herein by reference for all purposes.

### FIELD

The disclosure relates to quaternary metal chalcogenide nanoparticles that can be used as quaternary metal chalcogenide precursor inks and processes for manufacturing these inks The disclosure also relates to coated substrates comprising quaternary metal chalcogenide nanoparticles and provides processes for manufacturing these coated substrates. This disclosure also relates to compositions of quaternary metal chalcogenide thin films and devices comprising such films, and processes for manufacturing the same.

### BACKGROUND

Quaternary I₂-II-IV-VI₄ compound copper zinc tin sulfide (CZTS) is regarded as a promising photovoltaic material due to its excellent optoelectronic properties, tunable band gap, and earth-abundant elemental composition.

Various methods have been reported for the deposition of CZTS thin films, including the decomposition of molten salts, reactive sputtering, electroplating, vapor deposition, precursor solution deposition, and nanoparticle ink sintering. Of these methods, the approach using CZTS nanoparticle inks is one of the most promising, commonly achieving efficiencies over 8.5%,with the highest-efficiency nanoparticle-based CZTS solar cells reported to date (11.1%) being fabricated using a hydrazine-based synthesis route. This success is largely due to the better phase and compositional control achieved through solution processing, compared to the alternative synthesis approaches.

However, synthesis routes for the production of high-quality CZTS nanoparticles typically involve the use of toxic solvents and extensive post-synthesis processing to remove organic impurities. These are undesirable given that reproducibility and scale-up are essential for commercial production, which requires the minimization of hazards and additional processing steps. While existing “greener” CZTS nanoparticle syntheses based on water and ethanol dispersions overcome the risks associated with using toxic hydrazine, eliminating organic contaminants, which are usually present as an excess of aliphatic ligands used to achieve homogeneous dispersions of nanocrystals, remains a challenge. Furthermore, incomplete combustion of these organic ligands also forms insulating layers at interfaces following thermal annealing, generating trap states that enhance carrier recombination. Both of these effects reduce carrier transport properties and the concentration of charge carriers, resulting in lower device performance.

As ligands are required to stabilize colloidal nanoparticles, removing them or eliminating them entirely while maintaining stability in solution is impossible. A viable alternative is to replace these nonvolatile, long-chained aliphatic ligands with short-chained ligands that will readily vaporize during annealing. Another option is to remove carbon-containing stabilizing agents completely and use highly charged, molecular, metal chalcogenide ligands. By employing the latter approach, Tang et al. (Chem. Mater. 2014; 26; 3573) developed a method for fabricating CZTS thin films from aqueous dispersions containing alloyed CuS/ZnS nanoparticles coated with a tin metal chalcogenide. This organic-ligand-free approach yielded overall PV efficiencies above 5%, despite not using phase-pure CZTS nanoparticles.

It would be advantageous to synthesize CZTS nanoparticles that provide stoichiometric compositional, control and phase purity using a low-toxicity solvent while also yielding negligible residual carbon impurities following thermal annealing.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY

In one aspect there is provided a composition comprising quaternary metal chalcogenide nanoparticles stabilized by an inorganic metal-chalcogenide stabilizing agent, optionally including a reducing agent, wherein the nanoparticles are dispersible in a polar solvent. Preferably, the quaternary metal chalcogenide nanoparticles are copper zinc tin sulfide nanoparticles.

The composition comprising quaternary metal chalcogenide nanoparticles dispersed in a polar solvent can be used as a quaternary metal chalcogenide precursor ink.

In another aspect there is provided processes for manufacturing a composition comprising quaternary metal chalcogenide nanoparticles stabilized by an inorganic metal-chalcogenide stabilizing agent, optionally including a reducing agent, wherein the nanoparticles are dispersible in a polar solvent.

In another aspect there is provided coated substrates comprising a substrate and a coating, wherein the coating comprises one or more layers comprising the quaternary metal chalcogenide precursor inks

In another aspect there is provided processes for manufacturing coated substrates comprising a substrate and a coating, wherein the coating comprises the quaternary metal chalcogenide precursor inks

In another aspect there is provided processes for manufacturing quaternary metal chalcogenide thin films using the quaternary metal chalcogenide precursor inks The quaternary metal chalcogenide films can be used as absorbers in thin-film photovoltaic cells, gas sensors, photodetectors, and/or photolytic systems.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1. a) Metallic tin and sulfur redox reaction route to Sn-MCC. b) Tin (IV) sulfide dissociative route to Sn-MCC. c) A simplified process diagram for aqueous CZTS nanoink preparation.

FIG. 2. a) TEM image of CZTS nanocrystals with an elemental ratio of 2:1:1 Cu:Zn:Sn produced at an original concentration of 20 g/L showing substantially monodisperse square nanocrystals. Left Inset: histogram indicating a mean size of 13.4 nm b) High resolution TEM images showing the presence of crystal lattice spacings of 0.31 nm and 0.54 nm (light lines), and an inter-nanocrystal spacing of ˜0.8 nm (dark lines). Right Inset: The corresponding FFT image.

FIG. 3. a) 5 μm×5 μm low resolution tapping-mode AFM image of CZTS nanocrystals with an elemental ratio of 2:1:1 Cu:Zn:Sn spin coated onto a silicon wafer. b) High resolution AFM image of the square area of a) showing a topographic image of a single CZTS nanocrystal; c) AFM cross section of the single nanocrystal in b).

FIG. 4. a) FTIR spectra showing the functional groups present in the dried CZTS nanocrystal ink (bottom), twice washed and dried CZTS nanocrystals (middle), and twice washed and annealed at 250° C. CZTS nanocrystals (top).

FIG. 5. Raman spectra of twice washed and dried 2:1:1 CZTS nanocrystal powder a) as-prepared and b) annealed at 300° C. for 20 minutes, overlaid by the fits of the characteristic CZTS Raman peaks. c) PXRD patterns of the same nanocrystal powder at room temperature and d) after annealing at 300° C. for 20 minutes, overlaid by the fit of the sphalerite CZTS crystal phase and the difference between the experimental spectra and fit.

FIG. 6. Experimental elemental ratios obtained by ICP-MS analysis (dark dots) for CZTS samples prepared for synchrotron PXRD and Raman spectroscopy measurements overlaid with the corresponding theoretical elemental ratios (light dots). Variations between theory and experiment are within pipette and measurement error.

FIG. 7. Temperature dependent synchrotron PXRD data analysed for the 18 different elemental ratios shown in FIG. 6. a) Wt % of each crystal phase vs elemental composition Cu:Zn:Sn and temperature. Each crystal phase is indicated by a different colour with the intensity varying linearly with the wt % of each phase. b) Crystallite size of each crystal phase vs elemental composition Cu:Zn:Sn and temperature. Each crystal phase is indicated by a different colour with the intensity varying logarithmically with the crystallite size.

FIG. 8. SEM images of CZTS nanocrystals films on silicon wafers with an elemental ratio of 2:1:1 Cu:Zn:Sn produced at an original concentration of 20 g/L annealed at a) 400° C., b) 500° C., c) 600° C. & d) 700° C.

FIG. 9. a) TGA of a CZTS nanocrystal powder with elemental ratio of Cu:Zn:Sn 2:1:1 indicating most mass loss occurs at ˜180° C. b) The corresponding FTIR spectra vs. temperature with shading indicating the absorption (%) collected in tandem with the TGA in order to analyse the source of mass loss. Each set of peaks has been labelled with the corresponding functional groups and its source in the nano crystal ink.

### DETAILED DESCRIPTION

Reference will now be made in detail to certain embodiments of the invention. While the invention will be described in conjunction with the embodiments, it will be understood that the intention is not to limit the invention to those embodiments. On the contrary, the invention is intended to cover all alternatives, modifications, and equivalents, which may be included within the scope of the present invention as defined by the claims.

One skilled in the art will recognize many methods and materials similar or equivalent to those described herein, which could be used in the practice of the present invention. The present invention is in no way limited to the methods and materials described. It will be understood that the invention disclosed and defined in this specification extends to all alternative combinations of two or more of the individual features mentioned or evident from the text or drawings. All of these different combinations constitute various alternative aspects of the invention.

All of the patents and publications referred to herein are incorporated by reference in their entirety.

For purposes of interpreting this specification, terms used in the singular will also include the plural and vice versa.

As used herein, the term “chalcogen” refers to Group VI elements, and the terms “metal chalcogenides” or “chalcogenides” refer to materials that comprise metals and Group VI elements. Suitable Group VI elements include sulfur, selenium, and tellurium, preferably sulfur. Herein, the term “quaternary-metal chalcogenide” refers to a chalcogenide composition comprising three metals in an approximate charge balance with a chalcogenide. The three metals may comprise X₂-Y-Z compounds, wherein:

X is selected from the group consisting of Cu, Ag, Na, K, Li, Cs, and Au;

Y is selected from the group consisting of Zn, Cd, Fe, Ba, Mg, Ni, Co, Mn, Hg, Ca, and Sr; and

Z is selected from the group consisting of Sn, Ge, Si, Pb, and Zr.

Preferably, X is selected from Cu and Ag, Y is selected from Zn and Cd, and Z is selected from Sn and Ge.

Alternatively, the three metals may comprise X₂-Qₐ-Q_{b} compounds, wherein:

X is selected from the group consisting of Cu, Ag, Na, K, Li, Cs and Au; and

Qₐ is In and Q_{b} is Ga.

Suitable quaternary metal chalcogenides include, but are not limited to: CZTS, Cu₂ZnGeS₄, Cu₂CoSnS₄, Cu₂MnSnS₄, Cu₂NiSnS₄, Cu₂FeSnS₄, Cu₂MgSnS₄, Cu₂CdSnS₄, Cu₂SrSnS₄, Cu₂BaSnS₄, Cu₂MgSnS₄, Ag₂ZnSnS₄, Ag₂GeSnS₄, Ag₂MnSnS₄, Ag₂FeSnS₄, Ag₂CdSnS₄, Ag₂BaSnS₄, Li₂ZnSnS₄, Li₂GeSnS₄, Li₂MnSnS₄, Li₂FeSnS₄, Li₂CdSnS₄, Li₂CoSnS₄, Na₂ZnSnS₄, and Na₂CdSnS₄. In a preferred embodiment, the quaternary metal chalcogenide is copper zinc tin sulfide (CZTS).

Herein, the term “CZTS” refers to Cu₂ZnSnS₄. The term “CZTS” further encompasses copper zinc tin sulfide semiconductors with fractional stoichiometries, e.g., Cu_{1.8}Zn_{1.2}Sn_{0.95}S₄. That is, the stoichiometry of the elements can vary from strictly 2:1:1:4. Materials designated as CZTS can also contain small amounts of other elements such as sodium. In addition, the Cu, Zn and Sn in CZTS can be partially substituted by other metals. That is, Cu can be partially replaced by Ag, Na, K, Li, Cs, Au, and mixtures thereof; Zn by Cd, Fe, Ba, Mg, Ni, Co, Mn, Hg, Ca, Sr, and mixtures thereof; and Sn by Ge, Si, Pb, Zr, and mixtures thereof. Preferably, materials designated as CZTS consist essentially of Cu, Zn, Sn and S.

The term “nanoparticle” is meant to include chalcogenide containing particles characterized by a longest dimension of about 1 nm to about 1000 nm, or about 1 nm to about 500 nm, or about 1 nm to about 100 nm, or about 1 nm to about 50 nm, or about 1 nm to about 20 nm. Nanoparticles can be globular or in the shape of spheres, platelets, rods, wires, disks, or prisms. Herein, nanoparticle “size” or “size range” or “size distribution,” refers to the average longest dimension of a plurality of nanoparticles that falls within the specified range. “Longest dimension” is defined herein as the measurement of a nanoparticle from end to end along the major axis of the projection. The “longest dimension” of a particle will depend on the shape of the particle. For example, for particles that are roughly or substantially spherical, the longest dimension will be a diameter of the particle.

As defined herein, “coated particles” refers to quaternary metal chalcogenide nanoparticles that have organic or inorganic material, or a mixture thereof, bound to or associated with the surface. As defined herein, the terms “surface coating,” “stabilizing agent,” and “capping agent” are used interchangeably and refer to an adsorbed or chemically bonded monolayer of organic molecules, inorganic molecules, or mixtures thereof, at the surface of the particle(s). The stabilizing agent can aid in the dispersion of particles and can also inhibit their interaction and agglomeration in the ink.

### Quaternary Metal Chalcogenide Nanoparticles

In one embodiment, there is provided a composition comprising quaternary metal chalcogenide nanoparticles stabilized by an inorganic metal-chalcogenide stabilizing agent, optionally including a reducing agent, wherein the nanoparticles are dispersible in a polar solvent. Preferably, the quaternary metal chalcogenide nanoparticles are CZTS nanoparticles.

Suitable inorganic metal-chalcogenide stabilizing agents include zintl ions, wherein zintl ion refers to a polyanionic compound containing 2 or more elements, wherein at least one element is a metalloid selected from Groups 14-17, wherein the zintl ion when dissolved in a polar solvent dissociates from a cationic species.

Preferably the inorganic metal-chalcogenide stabilizing agent is a ligand used in the synthesis of the quaternary metal chalcogenide nanoparticles. The inorganic metal-chalcogenide stabilizing agent may provide a source of metal and chalcogenide elements in the nanoparticle synthesis, as well as electrostatically stabilize the formed nanoparticles in solution. The inorganic metal-chalcogenide stabilizing agent may merge with the crystal phase of the core crystal structure of the nanoparticles upon heating. The composition of the inorganic metal-chalcogenide stabilizing agent may depend on the composition of the nanoparticles. For CZTS nanoparticles, preferably the inorganic metal-chalcogenide stabilizing agent is selected from the group comprising, but not limited to: [Sn₂S₆]⁴⁻, [SnS₄]⁴⁻, [Sn₂S₃]²⁻, [Sn₂S₇]⁶⁻, [Sn₄S₁₁]⁶⁻, [Sn³S⁷]²⁻, [SnS₂]²⁻, [Sn₄S₁₅]¹⁶⁻, [SnS₃]²⁻, [Sn₂S₅]²⁻, and mixtures thereof, more preferably [Sn₂S₆]⁴⁻.

Compositions of nanoparticles stabilized with an inorganic metal-chalcogenide stabilizing agent may further include a reducing agent. Preferably the reducing agent is a mild reducing agent. In the context of this disclosure a mild reducing agent is a reducing agent which does not spontaneously react with water or oxygen and may only reduce a specific element or bond in a reaction by choosing an appropriate reduction potential. The reducing agent may be a stabilizing agent and adsorb or chemically bond to the nanoparticle surface. Preferably, the reducing agent decomposes and/or vaporizes at temperatures of less than about 300° C., 290° C., 280° C., 270° C., 260° C., 250° C., 240° C., 230° C., 220° C., 210° C., 200° C., 190° C., 180° C., 170° C., 160° C., or 150° C., preferably less than about 250° C., more preferably less than about 220° C. A reducing agent that decomposes and/or vaporizes at low temperatures (e.g., less than about 300° C.) may vaporize during annealing of a thin film comprised of nanoparticles and therefore does not substantially contaminate the thin film, for example, by forming an insulating layer at interfaces following thermal annealing, and/or generating trap states that enhance carrier recombination. Typically, reducing agents that decompose and/or vaporize at temperatures of less than about 300° C., have low-carbon and low-nitrogen content. In the context of this disclosure low-carbon and low-nitrogen content refers to molecules comprising about 5, 4, 3, 2, 1 or 0 atoms selected from C and N. Preferably the reducing agent comprises about 5, 4, 3, 2, 1 or 0 atoms selected from C and N. The composition of the reducing agent may depend on the nanoparticle composition. For CZTS nanoparticles, preferably the reducing agent is selected from the group comprising thiourea, thiourea derivatives, selenourea, selenourea derivatives, diborane, ascorbic acid, formic acid, phosphites, hypophosphites, dithiols, and mixtures thereof Preferably the reducing agent is thiourea.

In a particularly preferred embodiment, the quaternary metal chalcogenide nanoparticles are CZTS nanoparticles, the inorganic metal-chalcogenide stabilizing agent is Sn₂S₆⁴⁻, and the reducing agent is thiourea. Preferably, the inorganic metal-chalcogenide stabilizing agent and the reducing agent are derived from the synthesis of the CZTS nanoparticles in a polar solvent.

In a preferred embodiment, the composition comprising quaternary metal chalcogenide nanoparticles is substantially free of non-vaporizable organic stabilizing agents. In the context of this disclosure, a non-vaporizable organic stabilizing agent refers to a carbon-containing molecule with a boiling/decomposition temperature of at least 220° C., 230° C., 240° C., 250° C., 260° C., 270° C., 280° C., 290° C., 300° C., preferably at least 250° C., more preferably at least 220° C. Typically organic molecules with a boiling/decomposition temperature of at least 300° C. have carbon and/or nitrogen content sufficient to contaminate a thin film comprised of nanoparticles, for example, by forming an insulating layer at interfaces following thermal annealing, and/or generating trap states that enhance carrier recombination. Typically, organic molecules with a boiling/decomposition temperature of at least 300° C. have carbon and nitrogen content comprising at least 6 atoms selected from C and N.

Compositions comprising quaternary metal chalcogenide nanoparticles as described herein preferably contain essentially no carbon, nitrogen or oxygen which may contaminate a thin film comprised of the nanoparticles.

In a preferred embodiment, the amount of Cu, Zn, and Sn in the CZTS nanoparticles is in a molar ratio of 50:25:25. In some embodiments, the amount of Cu, Zn, and Sn in the CZTS nanoparticles can deviate from a 50:25:25 molar ratio by up to +/−10 mole %, +/−7.5 mole %, or +/−5 mole % for each element. In some embodiments, the amount of Cu, Zn, and Sn in the CZTS nanoparticles may be in a molar ratio of 50:25:25; 47.5:27.5:25; 47.5:25:27.5; 50:22.5:27.5; 52.5:22.5:25; 52.5:25:22.5; 50:27.5:22.5; 47.5:30:22.5; 45:27.5:27.5; 27.5:22.5:30; 52.5:20:27.5; 55:22.5:22.5; 52.5:27.5:20; 55:17.5:27.5; 50:17.5:32.5; 42.5:25:32.5; or 42.5:32.5:25. Preferably, the amount of Cu, Zn, and Sn in the CZTS nanoparticles is in a molar ratio of 50:25:25; 47.5:27.5:25; 47.5:25:27.5; 50:22.5:27.5; 52.5:22.5:25; 47.5:30:22.5; 45:27.5:27.5; 27.5:22.5:30; 52.5:20:27.5; 55:22.5:22.5; 55:17.5:27.5; 50:17.5:32.5; 42.5:25:32.5; or 42.5:32.5:25. More preferably, the amount of Cu, Zn, and Sn in the CZTS nanoparticles is in a molar ratio of 50:25:25. In a particularly preferred embodiment, the amount of Cu, Zn, Sn and S in the CZTS nanoparticles is approximately in a 2:1:1:4 molar ratio.

The quaternary metal chalcogenide nanoparticles may be amorphous, semi-crystalline, nanocrystalline, single crystals, or mixtures thereof. In one embodiment, the quaternary metal chalcogenide nanoparticles exhibit a substantially pure crystalline phase. The temis “pure crystalline phase” and “single crystalline phase” are used interchangeably. Preferably, the nanoparticles are single crystals and exhibit a substantially pure quaternary phase wherein the quaternary phase comprises greater than about 90 wt % of the total crystal phase wt %. In some embodiments, binary and/or ternary phases may also be present. Binary and ternary phases may include CuS, Cu₂S, CuS₂, ZnS, SnS, SnS₂, Cu₂SnS₃ and mixtures thereof. Preferably, binary and/or ternary phases comprise less than about 10 wt % of the total crystal phase wt %. In a particularly preferred embodiment, the nanoparticles exhibit a substantially pure quaternary phase, wherein the pure quaternary phase comprises greater than about 97 wt % of the total crystal phase wt %, and binary and/or ternary phases comprise less than about 3%.

The quaternary crystalline phase may be amorphous, sphalerite, kesterite, stannite, chalcopyrite, wurtzite, kesterite-wurtzite, stannite-wurtzite, or mixtures thereof. Preferably the quaternary crystalline phase is sphalerite, kesterite, stannite, or mixtures thereof. In a particularly preferred embodiment, the quaternary crystalline phase is sphalerite.

The quaternary crystalline phase may be controlled by heating. Nanoparticles that exhibit a first crystalline phase may be heated to exhibit one or more alternative crystalline phases, or mixtures thereof. In one embodiment, the first crystalline phase is sphalerite and the alternative crystalline phase is kesterite. Typically temperatures of at least about 300° C., 350° C., 400° C., 450° C., 500° C., 550° C., or 600° C., preferably at least about 400° C., may be used to transition the crystalline phase from a first crystalline phase to one or more alternative crystalline phases. The phase transition temperature may depend on the molar ratio of Cu, Zn, and Sn in the CZTS nanoparticles. Preferably, the nanoparticles may be heated to a temperature of at least about 300° C., preferably 400° C., without any phase transition.

In one embodiment, the quaternary metal chalcogenide nanoparticles exhibit a substantially monodisperse morphology. The morphology may be selected from the group consisting of globular, cubic, square and platelet morphologies, preferably platelet. The morphology may change upon heating.

The average nanoparticle size is preferably within the range of about 1 nm to 100 nm, about 1 nm to about 50 nm, about 1 nm to about 20 nm, about 2 nm to about 18 nm, about 5 nm to about 15 nm, about 10 nm to about 14 nm, with a size distribution of +/−20%, +/−15%, +/−10%, or +/−5%. The average nanoparticle size may increase upon heating.

Compositions comprising quaternary metal chalcogenide nanoparticles as described herein may be in powder form or dispersed in a polar solvent. Polar solvents include but are not limited to: water, deuterium oxide, water-soluble or water-miscible solvents, and mixtures thereof. Water-soluble or water-miscible solvents include but are not limited to: ammonia, alcohols, acetone, methyl ethyl ketone, acetonitrile, DMSO, and DMF. Examples of suitable alcohols include ethanol, methanol, isopropanol, and n-propanol. Preferably the polar solvent comprises water, optionally including ammonia. In embodiments wherein the polar solvent comprises water, the resultant aqueous solution may include buffering salts. The aqueous solution may include an ionic aqueous solution, including a high ionic strength aqueous solution.

### Processes for Preparing Quaternary Metal Chalcogenide Nanoparticles

Herein, the term “metal salts” refers to compositions wherein metal cations and inorganic anions are joined by ionic bonding. Relevant classes of inorganic anions comprise oxides, carbonates, sulfates, nitrates, acetates, sulfides and halides, preferably nitrates.

Herein, the term “metal complexes” refers to compositions wherein a metal is bonded to a surrounding array of molecules or anions, typically called “ligands” or “complexing agents.” The atom within a ligand that is directly bonded to the metal atom or ion is called the “donor atom” and, herein, often comprises nitrogen, oxygen, selenium, or sulfur, preferably sulfur.

In one aspect, there is provided a method of preparing a composition comprising quaternary metal chalcogenide nanoparticles as described herein. The method comprises reacting metal salts with a metal-chalcogenide complex, optionally including a reducing agent, in a polar solvent to form a polar dispersion of quaternary metal chalcogenide nanoparticles stabilized by an inorganic metal-chalcogenide stabilizing agent.

In a preferred embodiment, the method comprises:
a) providing a first polar solution comprising a metal-chalcogenide complex, optionally including a reducing agent;
b) adding a first metal salt to the first polar solution to form a second polar solution; and
c) reacting a second metal salt with the second polar solution; thereby forming a polar dispersion of quaternary metal chalcogenide nanoparticles stabilized by an inorganic metal-chalcogenide stabilizing agent.

The first metal salt comprises a metal ion with an oxidation state of 2⁺. The second metal salt comprises a metal ion with an oxidation state of 1⁺ or 2⁺. Where the second metal salt comprises a metal ion with an oxidation state of 2⁺, preferably the method includes a reducing agent. Where the second metal salt comprises a metal ion with an oxidation state of 1⁺, preferably the method does not include a reducing agent.

For CZTS nanoparticles, the first metal salt comprises metal salts of Zn(II), and the second metal salt comprises metal salts of Cu(I) or Cu(II). Suitable metal salts include Cu(I), Cu(II), Zn(II), oxides, carbonates, sulfates, nitrates, acetates, sulfides and halides, preferably. nitrates. Metal nitrate salts obviate the contamination of quaternary metal chalcogenide nanoparticles by halide ions and organic species, which can be difficult to remove during postprocessing. Advantageously, nitrate ions can be decomposed into nitric dioxide gas and water in the presence of an excess of ammonia above about 180° C.

The metal-chalcogenide complex provides a source of metal and chalcogenide elements for nanoparticle formation, as well as electrostatically stabilizes the resultant nanoparticles in solution and merges with the crystal phase upon heating. Preferably, the metal-chalcogenide complex used in the nanoparticle synthesis is the same as the inorganic metal-chalcogenide stabilizing agent of the resultant quaternary metal chalcogenide nanoparticles. Suitable metal-chalcogenide complexes include [Sn₂S₆]²⁻, [SnS₄]⁴⁻, [Sn₂S₃]²⁻, [Sn₂S₇]⁶⁻, [Sn₄S₁₁]⁶⁻, [Sn₃S₇]²⁻, [SnS₂]²⁻, [Sn₄S₁₅]¹⁶⁻, [SnS₃]²⁻, [Sn₂S₅]²⁻, and mixtures thereof, more preferably [Sn₂S₆]⁴⁻.

Preferably the reducing agent decomposes and/or vaporizes at temperatures of less than about 300° C., 290° C., 280° C., 270° C., 260° C., 250° C., 240° C., 230° C., 220° C., 210° C., 200° C., 190° C., 180° C., 170° C., 160° C., or 150° C., preferably less than about 250° C., more preferably less than about 220° C. More preferably, the reducing agent has low-carbon and low-nitrogen content. Preferably the reducing agent comprises about 5, 4, 3, 2, 1 or 0 atoms selected from C and N. Suitable reducing agents include thiourea, thiourea derivatives, selenourea, selenourea derivatives, diborane, ascorbic acid, fonuic acid, phosphites, hypophosphites, dithiols, and mixtures thereof. Preferably the reducing agent is thiourea. Thiourea converts Cu(II) to Cu(I) and provides a potential source of excess HS⁻ in solution. Excess HS⁻ in solution may minimize the formation of metal oxides and metal hydroxides. In aqueous solutions, thiourea decomposes above about 150° C. to cyanamide and isothiocyanic acid, which further decompose to ammonia and carbonyl sulphide and are released as gases. Thiourea therefore minimizes organic contaminants in thin films comprising the CZTS nanoparticles.

Preferably, the molar ratio of the reducing agent to the second metal salt is greater than 1, 1.1, 1.2, 1.3, 1.4, 1.5, 1.6, 1.7, 1.8, 1.9, or 2.0, preferably greater than 1.2.

Preferably, the metal-chalcogenide complex and the reducing agent simultaneously react with substantially all metal ions in the reaction mixture to form single-phase quaternary metal chalcogenide nanoparticles.

The first polar solution, second polar solution and polar dispersion comprise at least one polar solvent. The solvent composition of the first polar solution, the second polar solution and the polar dispersion may be the same or different. Polar solvents include but are not limited to: water, deuterium oxide, water-soluble or water-miscible solvents, and mixtures thereof. Water-soluble or water-miscible solvents include but are not limited to: ammonia, alcohols, acetone, methyl ethyl ketone, acetonitrile, DMSO, and DMF. Examples of suitable alcohols include ethanol, methanol, isopropanol, and n-propanol, Preferably the polar solvent comprises water, optionally including ammonia. In embodiments wherein the polar solvent comprises water, the resultant aqueous solution may include buffering salts. The aqueous solution may include an ionic aqueous solution, including a high ionic strength aqueous solution.

The reaction is typically conducted at a pH of greater than 7, 8, 9, 10, 11, 12, 13 or 14, preferably greater than 11.

The reaction is typically conducted at a temperature between about 30-45° C., preferably about 40° C.

The reaction is typically conducted at atmospheric pressure.

The reaction may be conducted under an atmosphere comprising oxygen or under an inert atmosphere, preferably under an inert atmosphere.

The polar dispersion of nanoparticles may be used as-synthesized. Alternatively, the nanoparticles may be purified by precipitation using a non-solvent, centrifugation, and redispersing the precipitate in a polar solvent. The nanoparticles may be isolated for example, by precipitation using a non-solvent, centrifugation, and vacuum dried to give the nanoparticles in powder form.

The resultant quaternary metal chalcogenide nanoparticles obtained from this synthetic route are coated with the inorganic metal chalcogenide stabilizing agent. The nanoparticles may also be coated with the reducing agent.

Advantageously the coated quaternary metal chalcogenide nanoparticles may be used as-synthesized and do not require post-processing to alter the surface chemistry. The ligands used in the synthesis either merge with the crystal lattice (in the case of the metal-chalcogenide complex) or comprise one or more properties selected from low-carbon and low-nitrogen content, high volatility and low decomposition temperature. Nanoparticles coated with such stabilizing agents can lead to annealed films of high purity and favourable semiconductor properties. It is believed that films with lower levels of carbon impurities derived from the stabilizing agent(s) are desirable. Although the coated quaternary metal chalcogenide nanoparticles can be further treated with an alternative stabilizing agent to replace the initial stabilizing-agent(s) with the alternative stabilizing agent, preferably the coated nanoparticles comprise stabilizing agents derived from their synthesis.

### Precursor Inks

Polar dispersions comprising quaternary metal chalcogenide nanoparticles as described herein can be used as a quaternary metal chalcogenide precursor ink.

This ink is referred to as a quaternary metal chalcogenide precursor ink, as it contains the precursors for forming a quaternary metal chalcogenide thin film. In some embodiments, the ink consists essentially of a polar dispersion comprising the coated quaternary metal chalcogenide nanoparticles.

The precursor ink comprises a polar solvent fluid medium to carry the particles. The fluid medium typically comprises 30-99 wt %, 50-95 wt %, 60-90 wt %, 50-98 wt %, 60-98 wt %, 70-98 wt %, 75-98 wt %, 80-98 wt %, 85-98 wt %, 75-95 wt %, 80-95 wt %, or 85-95 wt % of the total weight of the CZTS precursor ink. Herein, all reference to wt % of particles is meant to include any surface coating that may be present.

In addition to the fluid medium and the coated quaternary metal chalcogenide nanoparticles, the precursor ink can optionally further comprise additives. Preferably, the precursor ink is additive-free.

In embodiments whereby the precursor ink further comprises one or more additives, the additives may be selected from the group consisting of dispersants, surfactants, polymers, binders, cross-linking agents, emulsifiers, anti-foaming agents, dryers, fillers, extenders, thickening agents, film conditioners, anti-oxidants, flow agents, leveling agents, defoamers, plasticizers, thixotropic agents, viscosity modifiers, dopants, and corrosion inhibitors. Typically, the additives comprise less than 20 wt %, or less than 10 wt %, or less than 5 wt %, or less than 2 wt %, or less than 1 wt % of the CZTS precursor ink. Preferably, the precursor ink does not include an additive. It will be clear to a skilled person that in the context of this disclosure an additive does not include the stabilizing agent.

### Coated Substrates

In another aspect, there is provided a process comprising depositing a precursor ink onto a substrate to form a coated substrate, wherein the precursor ink comprises a polar dispersion comprising quaternary metal chalcogenide nanoparticles.

In one embodiment there is provided a coated substrate comprising:
a) a substrate; and
b) at least one layer deposited on the substrate comprising a precursor ink comprising quaternary metal chalcogenide nanoparticles.

The precursor ink is deposited on a surface of a substrate by any one of several conventional coating or printing techniques, e.g., spin-coating, doctor blade-coating, spray coating, dip-coating, rod-coating, drop-cast coating, wet coating, roller coating, slot-die coating, meyerbar coating, capillary coating, ink-jet printing, draw-down coating, contact printing, gravure printing, flexographic printing, screen printing and electrophoretic deposition. The coating can be dried by evaporation, by applying vacuum, by heating, or by combinations thereof. In some embodiments, the coated substrate is heated at a temperature from about 40-550° C., about 80-400° C., about 80-350° C., about 100-300° C., about 150-250° C., about 180-250° C., or about-180-220° C. to remove at least a portion of the solvent, if present, by-products, and volatile capping agents. In some embodiments, the drying step is carried out under an inert atmosphere. In some embodiments, the drying step is carried out under an atmosphere comprising oxygen. The drying step can be a separate, distinct step, or can occur as the coated substrate is heated in an annealing step. The substrate can be rigid or flexible. In one embodiment, the substrate comprises: (i) a base; and (ii) optionally, an electrically conductive coating on the base. The base material is selected from the group consisting of glass, metals, ceramics, and polymeric films. Suitable base materials include metal foils, plastics, polymers, metalized plastics, glass, solar glass, low-iron glass, green glass, soda-lime glass, metalized glass, steel, stainless steel, aluminium, ceramics, metal plates, metalized ceramic plates, and metalized polymer plates. In some embodiments, the base material comprises a filled polymer (e.g., a polyimide and an inorganic filler). In some embodiments, the base material is coated with a thin insulating layer (e.g., alumina or zirconia). Suitable electrically conductive coatings include metal conductors, transparent conducting oxides, and organic conductors.

Of particular interest are substrates of molybdenum-coated-soda-lime glass and molybdenum-coated polyimide films

In some embodiments, the molar ratio of Cu:Zn:Sn in the coating on the substrate is 2:1:1. In other embodiments, the molar ratio of Cu:(Zn+Sn) is less than one, and the molar ratio of Zn:Sn is greater than one (e.g., Cu_{1.8}Zn_{1.2}Sn_{0.95}S₄).

By varying the precursor ink concentration, solvent, additives, and/or coating technique and temperature, layers of varying thickness can be coated in a single coating step. In some embodiments, the coating thickness can be increased by repeating the coating and drying steps.

### Formation of Thin Films

In another aspect, there is provided a thin film comprising a coated substrate as described herein, wherein the layer of the coated substrate comprising the precursor ink comprising quaternary metal chalcogenide nanoparticles comprises substantially annealed nanoparticles. In a preferred embodiment, the molar ratio of metal and chalcogenide elements in the thin film is substantially similar to the molar ratio of metal and chalcogenide elements of the nanoparticles in the precursor ink.

In another aspect, there is provided a process comprising annealing the coated substrate to form an annealed thin film. The annealing step comprises heating the coated substrate to remove residual solvent, and if present, by-products, and volatile capping agents, and to improve at least one film characteristic selected from reducing grain boundaries, trap states, and pinholes. The annealed film typically has an increased density and/or reduced thickness compared to that of the unannealed coated substrate.

Advantageously, quaternary metal chalcogenide nanoparticles as described herein are amenable to low annealing temperatures. The reducing agent decomposes at annealing temperatures of less than about 250° C., preferably less than about 220° C., leaving substantially pure inorganic nanoparticles, which enables direct contact, and thus charge transport, between particles in a continuous film. In some embodiments, the coated substrate is heated at about 100-550° C., about 100-300° C., about 150-250° C., about 180-250° C., or about 180-220° C. More particularly, the coated substrate may be heated using annealing temperatures of less than about 300° C., 290° C. 280° C., 270° C., 260° C., 250° C., 240° C., 230° C., 220° C., 210° C., 200° C., 190° C., or 180° C. Preferably, low annealing temperatures may be used, such as about 180-250° C.

Low annealing temperatures also advantageously maintain control over the stoichiometry of the elements in the annealed film. At higher temperatures for example (e.g. above 300° C.) tin-loss may be observed due to the formation of SnS.

Preferbaly, the molar ratio of metal and chalcogenide elements in the thin film is substantially similar to the molar ratio of metal and chalcogenide elements of the nanoparticles in the precursor ink. The ratio of Cu:Zn: Sn in the quaternary metal chalcogenide nanoparticles may be tuned during the synthesis of the nanoparticles. In a preferred embodiment, the ratio of Cu:Zn:Sn in a CZTS precursor ink is substantially the same as the ratio of Cu:Zn:Sn in an annealed film of CZTS derived from a coating of that ink.

In some embodiments, the molar ratio of Cu:Zn:Sn is 2:1:1 in the annealed film. In some embodiments, the molar ratio of Cu:(Zn+Sn) is less than one and the molar ratio of Zn:Sn is greater than one in an annealed film comprising CZTS nanoparticles.

Preferably, the annealing is carried out in the absence of a chalcogen vapor source.

In some embodiments, the coated substrate is heated for a time in the range of about 1 min to about 48 h; 1 min to about 30 min; 10 min to about 10 h; 15 min to about 5 h; 20 min to about 3 h; or, 30 min to about 2 h.

Typically, annealing may be conducted using thermal processing, rapid thermal processing (RTP), rapid thermal annealing (RTA), pulsed theinial processing (PTP), laser beam exposure, heating via IR lamps, electron beam exposure, pulsed electron beam processing, heating via microwave irradiation, flash light annealing, or combinations thereof. Preferably annealing may be conducted using thermal processing.

The annealed film typically has an increased density and/or reduced thickness compared to that of the unannealed coated substrate. In some embodiments, the film thicknesses of the dried and annealed coatings are 2.5 nm -200 microns; 0.1-100 microns; 0.1-50 microns; 0.1-25 microns; 0.1-10 microns; 0.1-5 microns; 0.1-3 microns; 0.3-3 microns; or 0.5-2 microns.

### Photovoltaic Cells

In another embodiment, there is provided processes for forming photovoltaic cells comprising:
a) coating a photovoltaic cell substrate with a polar dispersion comprising quaternary metal chalcogenide nanoparticles stabilized by an inorganic metal chalcogenide stabilizing agent;
b) heating the coated photovoltaic cell substrate to form an annealed CZTS thin film on the photovoltaic cell substrate;
c) optionally repeating steps a) and b) to form a CZTS film of the desired thickness;
d) optionally depositing a buffer layer onto the CZTS layer;
e) depositing an N-type layer onto the CZTS layer or buffer layer;
f) depositing at least one top contact layer onto the N-type layer;
g) depositing an electrode onto the top contact layer.

In another embodiment, there is provided a photovoltaic cell comprising a photovoltaic cell substrate comprising an annealed CZTS thin film, wherein the annealed CZTS thin film is derived from a polar dispersion comprising quaternary metal chalcogenide nanoparticles stabilized by an inorganic metal chalcogenide stabilizing agent.

Suitable substrate materials for the photovoltaic cell substrate include glass, metals or polymers. The substrate can be rigid or flexible. If the substrate material is not itself a conductor (e.g., a metal), the substrate comprises a conductive coating. Suitable substrate materials include soda-lime glass, polyimide films; solar glass, low-iron glass, green glass, steel, stainless steel, aluminium, and ceramics. Suitable photovoltaic cell substrates include molybdenum-coated soda-lime glass, molybdenum-coated polyimide films, metalized ceramic plates, metalized polymer plates, and metalized glass plates.

Typical photovoltaic cell substrates are glass or plastic, coated on one side with a conductive material, e.g., a metal. In one embodiment, the substrate is molybdenum-coated glass.

Depositing and annealing the CZTS layer on the photovoltaic cell substrate can be carried out as described above.

The buffer layer typically comprises an inorganic material such as CdS, ZnS, zinc hydroxide, Zn (S, O, OH), cadmium zinc sulfides, In(OH)₃, In₂S₃ , ZnSe, zinc indium selenides, indium selenides, zinc magnesium oxides, SnO₂, TiO₂, or n-type organic materials, or combinations thereof. Layers of these materials can be deposited by chemical bath deposition, atomic layer deposition, coevaporation, sputtering or chemical surface deposition to a thickness of about 1 nm to about 1000 nm, or from about 5 nm to about 500 nm, or from about 10 nm to about 300 nm, or 40 nm to 100 nm, or 50 nm to 80 nm.

The N-type layer typically comprises an inorganic material such as i-ZnO, zinc magnesium oxides, Zn (S, O, OH) or n-type organic materials, or combinations thereof. Layers of these materials can be deposited by chemical bath deposition, atomic layer deposition, coevaporation, sputtering or chemical surface deposition to a thickness of about 2 nm to about 1000 nm, or from about 5 nm to about 500 nm, or from about 10 nm to about 300 nm, or 40 nm to 100 nm, or 50 nm to 80 nm.

The top contact layer is typically a transparent conducting oxide, e.g., indium tin oxide, aluminum-doped zinc oxide, graphene, cadmium stannate, or silver/gold nanowires. Suitable deposition techniques include sputtering, evaporation, chemical bath deposition, chemical surface deposition, electroplating, chemical vapor deposition, physical vapor deposition, and atomic layer deposition. Alternatively, the top contact layer can comprise a transparent conductive polymeric layer, e.g., poly-3,4-ethylenedioxythiophene (PEDOT) doped with poly(styrenesulfonate) (PSS), which can be deposited by standard methods, including spin coating, dip-coating or spray coating.

One advantage of using a polar dispersion comprising single-phase quaternary metal chalcogenide nanoparticles as the precursor ink is that the nanoparticles are easily prepared. Another advantage is that the overall ratios of copper, zinc, tin and chalcogenide in the precursor ink can be easily varied to achieve optimum performance of the photovoltaic cell. Another advantage is that the nanoparticles can be annealed at low temperatures, allowing the use of a wider range of substrates for the photovoltaic cells. Another advantage is that the dense packing of the nanoparticles leads to a dense and smooth film.

### Gas Sensors

In another embodiment, there is provided a gas sensor comprising a gas sensor substrate comprising an annealed CZTS thin film, wherein the annealed CZTS thin film is derived from a polar dispersion comprising quaternary metal chalcogenide nanoparticles stabilized by an inorganic metal chalcogenide stabilizing agent.

Depositing and annealing a CZTS layer on a gas sensor substrate can be carried out as described above. Preferably, the gas sensor substrate is a porous film. Preferably, the CZTS layer is deposited on the gas sensor substrate by spray coating.

### Photodetectors

In another embodiment, there is provided a photodetector comprising a photodetector substrate comprising an annealed CZTS thin film, wherein the annealed CZTS thin film is derived from a polar dispersion comprising quaternary metal chalcogenide nanoparticles stabilized by an inorganic metal chalcogenide stabilizing agent.

Depositing and annealing a CZTS layer on a photodetector substrate can be carried out as described above. Preferably, the CZTS layer is deposited into an array by electrophoretic deposition.

### EXAMPLES

All metal salts and reagents were obtained from commercial sources and used as received unless otherwise noted. Tin powder was stored in a glove box under a nitrogen atmosphere to prevent oxidation. Deionized water was obtained from a Milli-Q system (18.2 MΩ.cm resistivity). Reaction containers were polypropylene specimen containers with polypropylene screw caps purchased from Techno Plas.

Tin (IV) sulfide was synthesized via reaction of sodium sulfide nonahydrate and tin (IV) chloride pentahydrate in water. Tin (IV) sulfide was purified by vacuum filtration and washing with Milli-Q water.

### Preparation of Tin Metal Chalcogenide

Tin metal chalcogenide is exemplary of the inorganic metal chalcogenide complex described herein.

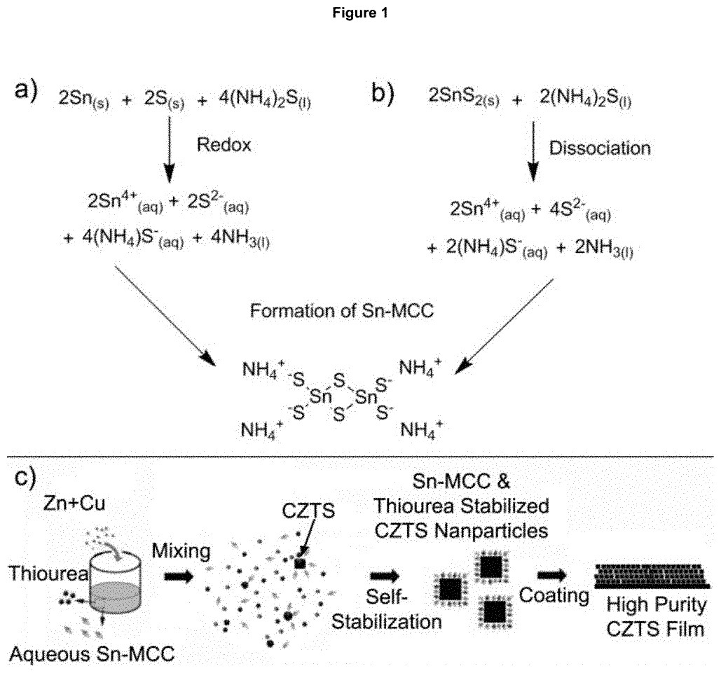

Tin metal chalcogenide (Sn-MCC) solutions were prepared by two routes: (i) a redox route using pure tin and sulfur powders and (ii) a dissociative route using tin (IV) sulfide. These are shown schematically in FIG. 1 a & b.

Redox route: Tin powder (5 mmol, 0.594 g) and sulfur powder (10 mmol, 0.321 g) were added to a reaction container and sealed under a nitrogen atmosphere to prevent the premature oxidation of tin. Ammonium-sulfide (4.44 mL) and then Milli-Q water (2.5 mL) were quickly added to the reaction container in air before resealing to prevent the loss of ammonia during the reaction. The original mustard-coloured, turbid mixture was allowed to react with stirring until no more unreacted tin was present (˜45 minutes), with the temperature maintained at 40° C. using a water bath. This yielded a 0.36 M Sn₂S₆⁴⁻ transparent solution (2.5 mmol in 13% ammonium-sulfide water, 6.94 mL) with a deep-orange colour.

Dissociative route: Tin (IV) sulfide powder (5 mmol, 0.914 g) was added to ammonium-sulfide (4.44 mL) and Milli-Q water (2.5 mL), then the reaction container was sealed to prevent the loss of ammonia during the reaction. The original mustard-coloured, turbid mixture was allowed to react with stirring until no more solid was present (˜4 minutes), with the temperature maintained at 40° C. using a water bath. This yielded a 0.36 M Sn₂S₆⁴⁻ solution comparable to that obtained via the redox route.

Aqueous Sn-MCC solutions slowly degrade to a black precipitate of tin oxide. The rate of degradation is significantly slower for Sn-MCC prepared via the dissociation route (6 days for 1 mg of precipitate) compared to Sn-MCC synthesised via the redox route (3 hours for 1 mg of precipitate). In a preferred embodiment, Sn-MCC is prepared via the dissociation route.

### Synthesis of CZTS Nanocrystals

A typical synthesis of CZTS nanocrystals with an elemental ratio of 2:1:1 Cu:Zn:Sn and total metal concentration of 40 g/L is as follows: a 1 M thiourea solution (12 mmol in 12 mL of Milli-Q water) and a 0.36 M Sn-MCC solution (2.5 mmol in 6.94 mL of 13% ammonium-sulfide water) were added to Milli-Q. water (34 mL, to adjust the final ink concentration to 40 g/L) at 40° C. with stirring. A 0.76 M Zn(NO₃)₂ solution (5 mmol in 6.54 mL of 18% ammonia solution) was then added, causing the formation of a pale yellow precipitate, which redissolved within 2 minutes to return the solution to its original transparent orange appearance. Once the solution was completely transparent, a 3.02 M Cu(NO₃)₂ solution (10 mmol in 3.31 mL of Milli-Q water) was added quickly with stirring, causing the immediate formation of a dark red/black CZTS nanocrystal ink. The yield by mass was ≥95% (2.4 g of dried CZTS-nanocrystals). This synthetic method was successfully scaled-up to produce 50 g of dried CZTS nanocrystal powder.

CZTS nanocrystals of different elemental ratios and concentrations can be synthesised stoichiometrically by the addition of different amounts of copper, zinc, and tin precursor solutions while keeping a ˜1.2-fold excess of thiourea to copper ions in solution. This synthesis can be varied to make any of the nanocrystal inks described herein at concentrations of up to ˜80 g/L.

### Characterisation

As-synthesised CZTS ink powders were obtained by vacuum drying at 40° C. Purified CZTS nanocrystal powders were obtained by adding ethanol or isopropanol as an antisolvent, centrifuging at >2100 rcf (˜5 mins), disposing of the supernatant and redispersing the precipitant in Milli-Q water. This process was repeated 2-3 times and finally the precipitant was vacuum dried at 40° C.

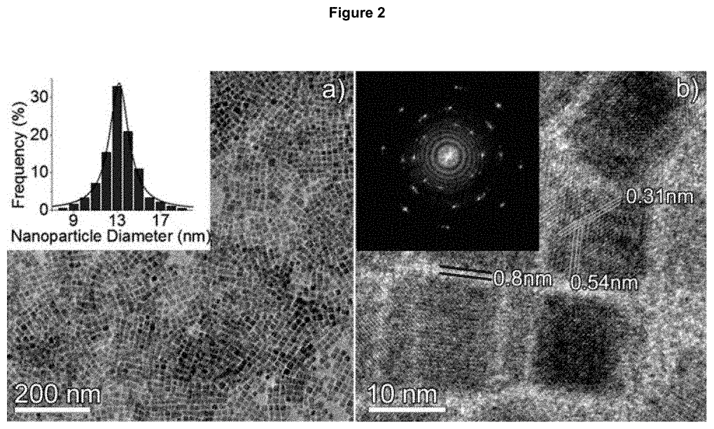

TEM was carried out in order to identify the size distribution and morphology of the nanocrystals produced. FIG. 2 a) shows monodisperse cubic or square CZTS nanocrystals with an average width of 13.4 nm and a standard deviation of 1.7 nm. The high resolution TEM (HR-TEM) image shown in FIG. 2 b) reveals the presence of crystal lattice spacings of ˜0.31 nm and ˜0.54 nm, which are consistent with the inter-planar d₁₁₂ spacing of sphalerite and kesterite CZTS phases, and the lattice constant a, respectively.

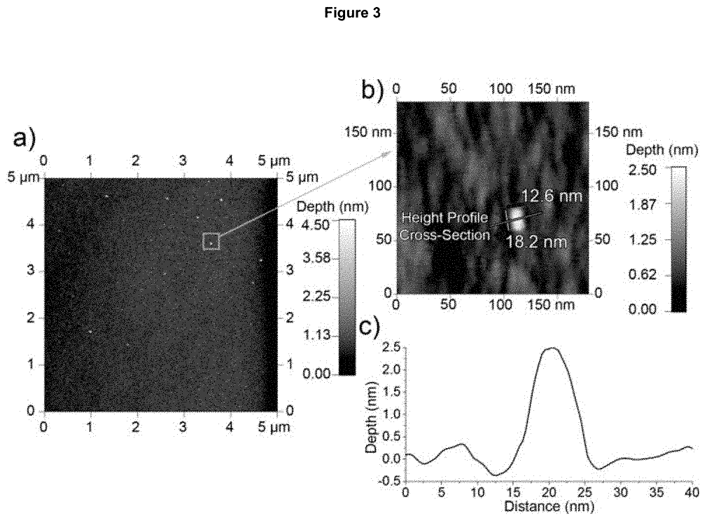

AFM was used to measure the nanocrystal thickness (FIG. 3). FIG. 3 a) shows a low-resolution, tapping-mode AFM measurement of discrete CZTS nanocrystals on a silicon wafer. These revealed uniform nanocrystals with little variation in width or height. A high resolution AFM image of a single CZTS nanocrystal is presented in FIG. 3 b). A typical cross-section is shown in FIG. 3 c). The AFM data indicates the CZTS nanocrystals are square plates with a mean height of 2.5 nm±0.8 nin.

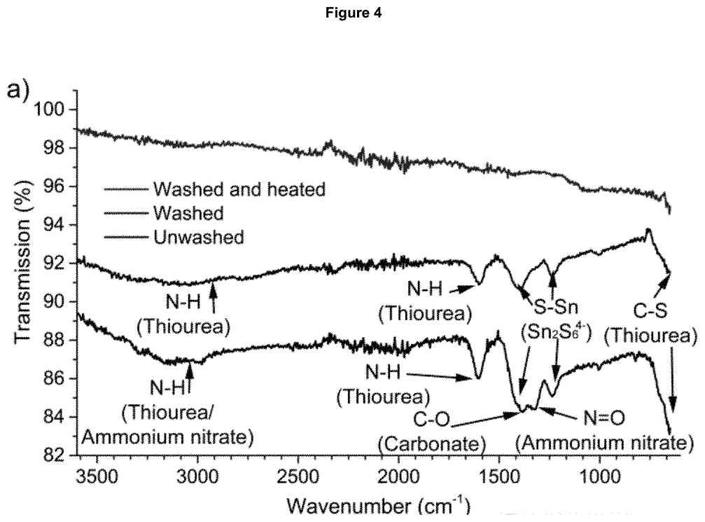

FTIR was used to identify the surface bound molecules (FIG. 4 a). In the unwashed ink, all of the expected functional groups stemming from the original reaction chemistry were present, except the C═S vibration from thiourea at 1140 cm⁻¹. A C—S peak at 700 cm ⁻¹ was observed, which, without wishing to be bound by theory, implies that the thiourea may be bound to the surface of the nanocrystals by a sulfur bond as C—S—CZTS. After purifying the nanocrystals, only the surface bound groups S—Sn, N—H and C—S were present, corresponding to Sn₂S₆⁴⁻ and thiourea, respectively.

### Crystal Phase Quality of CZTS Nanocrystals

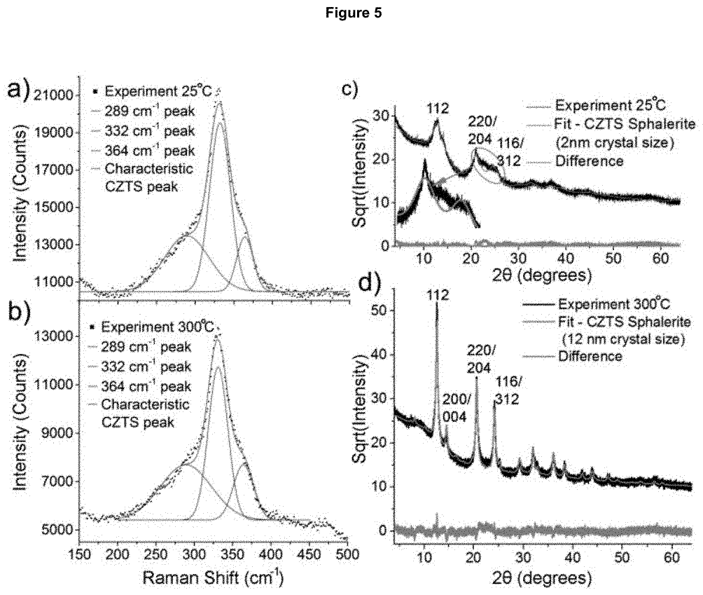

Synchrotron PXRD- and Raman spectroscopy was used to determine the CZTS crystal phase. CZTS nanocrystals were prepared as described above, washed twice with ethanol, and dried at 40° C. under vacuum to give a dry nanocrystal powder. Raman spectra of the crystals were collected (i) as-prepared and (ii) after annealing at 300° C. for 20 minutes in a nitrogen filled tube furnace (FIG. 5 a) & b), respectively). The experimental data for 2:1:1 CZTS nanocrystals were overlaid by the fits to the characteristic CZTS Raman peaks and indicate the formation of a pure CZTS phase at both temperatures.

The two temperatures, 25° C. and 300° C., were selected from temperature dependent XRD measurements to match the Raman spectra, and also to give an example of the quality of the XRD phase fitting analysis. The experimental PXRD patterns and their corresponding phase fits are shown in FIG. 5 c) & d) in dark and light lines, respectively. The 25° C. sample PXRD pattern in FIG. 5 c) shows broad diffraction peaks, which could be identified as any of a number of phases. In contrast, the diffraction pattern of the sample treated at 300° C. in FIG. 5 d) exhibits well-defined peaks, with good agreement to a fit that assumes a 100% sphalerite CZTS phase with a crystallite size of 12 nm. These results suggest that the sphalerite CZTS nanocrystals grow from 2 nm to 12 nm between 25° C. and 300° C. without any intervening phase transitions.

### Phase Map of Annealed Compositionally-Variant CZTS Nanocrystals

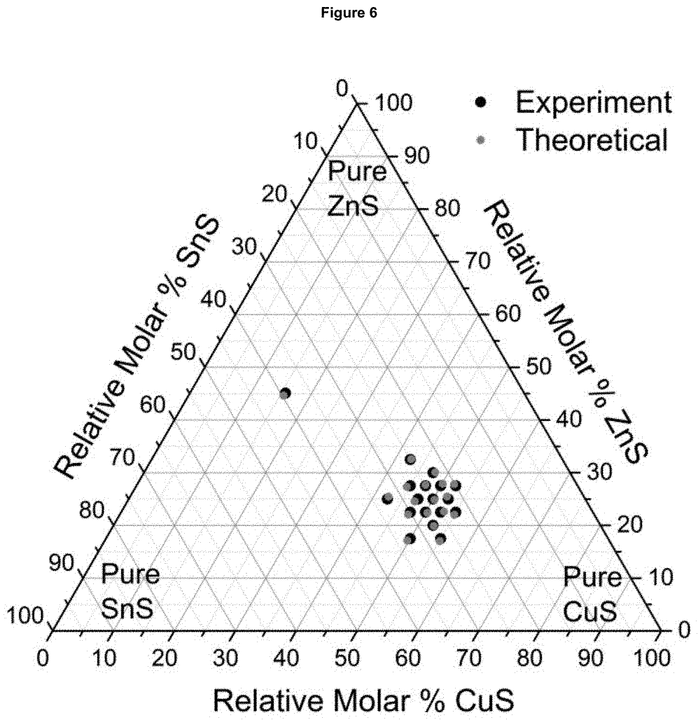

18 different compositions of CZTS nanocrystals were analysed by both synchrotron PXRD and Raman spectroscopy. Samples were prepared with theoretical elemental ratios as shown in FIG. 6, at a concentration of 20 g/L, washed twice with ethanol, and dried at 40° C. under vacuum to give a dry nanocrystal powder. ICP-MS was performed on the precipitates to compare the theoretical and experimental elemental ratios (see FIG. 6). The values were found to be within measurement and pipetting errors (<0.5%), thus confirming that the synthetic method is stoichiometric.

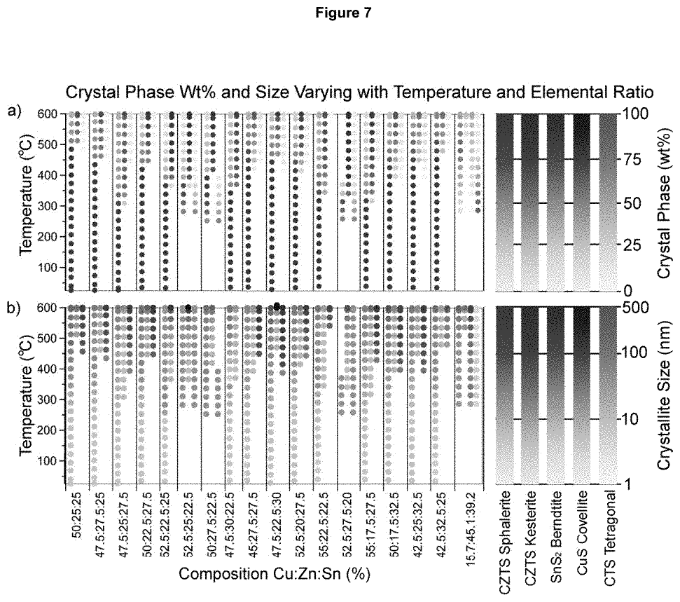

To construct a crystal phase map of our nanocrystals with composition vs temperature, synchrotron PXRD patterns were collected from 26° C. to 600° C. for each nanocrystal powder sample analysed with ICP-MS. Samples were loaded into capillaries with a nitrogen over-pressure applied to ensure no oxygen entered the system. The wt % of each crystal phase vs elemental composition Cu:Zn:Sn and temperature are presented in FIG. 7 a), with each crystal phase indicated by a different colour, with the intensity varying linearly with wt %. Generally, the phase of the as-synthesised nanocrystals is sphalerite CZTS. As the temperature is increased, a clear shift from sphalerite CZTS to kesterite CZTS occurs, although this transition is at different temperatures for different compositions.

To capture the critical trends across the multi-dimensional parameter map for the CZTS nanocrystal synthesis, the crystallite sizes of each phase as a function of both elemental composition Cu:Zn:Sn and temperature are shown in FIG. 7 b), with each crystal phase indicated by a different colour, while the colour intensity of the spots varies logarithmically with crystallite size. A clear sharpening of the XRD peaks is evident through the deepening spot colour as the temperature increases to 600° C. This corresponds to the growth of the crystallites. This growth occurred in a pure nitrogen atmosphere, i.e. in the absence of either a sulfur or a selenium atmosphere. A chalcogenide atmosphere is known to enhance grain growth kinetics due to the dissolution and reformation of the anion-based lattice.

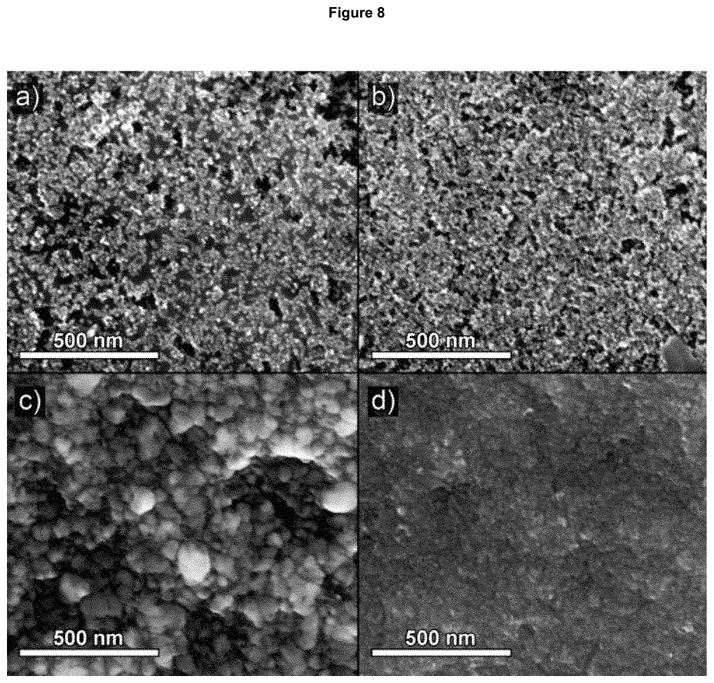

SEM images of the CZTS nanocrystal films with a composition (%) of 50:25:25 (FIG. 8) were taken in order to confirm the crystallite growth calculated from the PXRD patterns. The nanocrystal film annealed at 400° C. in FIG. 8 a) shows a crystallite size of ˜12 nm, the same size as calculated by PXRD. The film exhibits a globular morphology, indicating the square plate-like nanocrystals deformed with melting, however they are still largely isolated with only slight necking. Upon heating to 500° C. the crystals begin to fuse and form clusters (FIG. 8 b)).

A mean crystallite size of ˜32 nm is calculated from the PXRD pattern which is reasonable for these clusters. Large crystallites of ˜130 nm are observed in FIG. 8 c) for a film annealed at 600° C. corresponding to large-scale fusion of the clusters. Once again this is also observed in the PXRD pattern. Heating these large crystallites to 700° C. results in widespread melting and growth, creating a seemingly continuous crystallite film composed of crystals several micrometres in length.

TABLE 1
Raman phases observed for the 18 different elemental
ratios shown in FIG. 6 & FIG. 7 as synthesised and
after annealing at 300° C. for 20 minutes.

| % Cu:Zn:Sn | Phases 25° C. | Phases 300° C. |
|---|---|---|
| 50:25:25 | CZTS | CZTS |
| 47.5:27.5:25 | CZTS | CZTS |
| 47.5:25:27.5 | CZTS | CZTS |
| 50:22.5:27.5 | CZTS | CZTS |
| 52.5:22.5:25 | CZTS | CZTS |
| 52.5:25:22.5 | CuS & CZTS | CuS & CZTS |
| 50:27.5:22.5 | CuS & CZTS | CuS & CZTS |
| 47.5:30:22.5 | CZTS | CZTS |
| 45:27.5:27.5 | CZTS | CZTS |
| 27.5:22.5:30 | CZTS | CZTS |
| 52.5:20:27.5 | CZTS | CZTS |
| 55:22.5:22.5 | CZTS | CZTS |
| 52.5:27.5:20 | CuS & CZTS | CuS & CZTS |
| 55:17.5:27.5 | CZTS | CZTS |
| 50:17.5:32.5 | CZTS | CZTS |
| 42.5:25:32.5 | CZTS | CZTS |
| 42.5:32.5:25 | CZTS | CZTS |

The Raman spectroscopy measurements for each composition are summarized in Table 1. No compositions exhibit a ZnS peak, indicating pure-phase sphalerite CZTS in their corresponding PXRD analysis. The crystal phases observed by Raman spectroscopy are consistent with the phases observed by PXRD.

### Thermal Decomposition Characteristics of CZTS Nanocrystals

For thin film applications, the nanocrystals should require minimal post-synthesis processing, such as centrifugation, filtering or precipitation steps, and have no impurities upon mild annealing. TGA-FTIR was used in order to identify at what temperatures the different components of the un-washed nanocrystal ink vaporise.

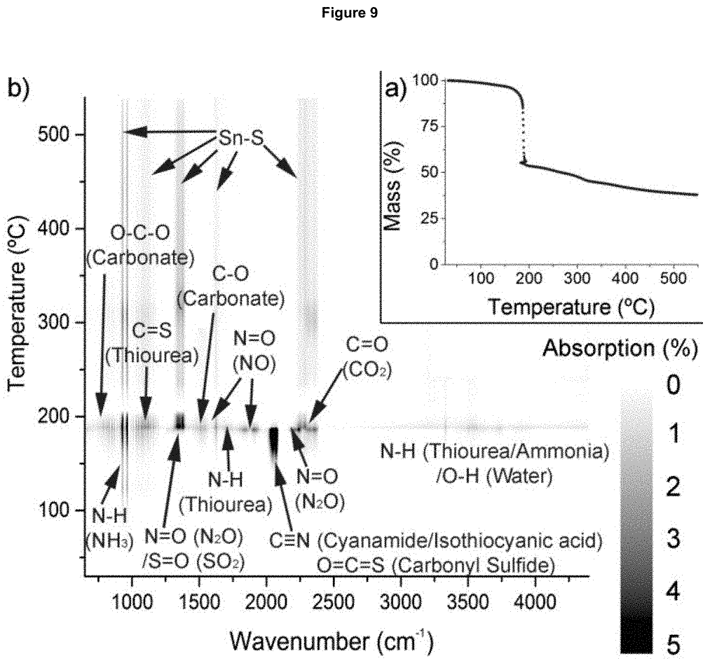

The initial slow mass loss below 150° C. evident in the TGA curve, FIG. 9 a), is due to evaporation of residual ammonia (˜3%), followed by the initial loss of thiourea as cyanamide and isothiocyanic acid, which starts at ˜150° C.

In the presence of water released from other decomposition reactions at ˜180° C. isothiocyanic acid further decomposes to carbonyl sulfide. The sharp mass decrease between 170-185° C. (˜40%) largely corresponds to the continued loss of thiourea (15.2%), then the subsequent loss of nitrate (19.6%) and carbonate (˜5%) anions. The percentages of each component are calculated based on the percent mass of thiourea and ammonium nitrate in the initial ink. The remaining percentage mass loss is attributed to carbonate species.

At an annealing temperature of ˜185° C. substantially all undesirable components in the nanocrystal ink decompose and/or vapourise, and there is no detectable loss of SnS, so the stoichiometry of CZTS does not change during annealing.

What is claimed is:

1. A composition comprising quaternary metal chalcogenide nanoparticles stabilized by an inorganic metal-chalcogenide stabilizing agent, wherein the nanoparticles are dispersible in a polar solvent.

2. A composition according to claim 1, wherein the quaternary metal chalcogenide nanoparticles substantially comprise CZTS nanoparticles.

3. A composition according to claim 1, wherein the inorganic metal-chalcogenide stabilizing agent is selected from the group consisting of: [Sn₂S₆]⁴⁻, [SnS₄]⁴⁻, [Sn₂S₂]²⁻, [Sn₂S₇]⁶⁻, [Sn₄S₁₁]⁶⁻, [Sn₃S₇]²⁻, [SnS₂]²⁻, [Sn₄S₁₅]¹⁶⁻, [SnS₃]²⁻, [Sn₂S₅]²⁻, and mixtures thereof.

4. A composition according to claim 1, wherein the composition includes a reducing agent, wherein the reducing agent decomposes and/or vaporize at temperatures of less than about 220° C.

5. A composition according to claim 4, wherein the reducing agent is selected from the group consisting of: thiourea, thiourea derivatives, selenourea, selenourea derivatives, diborane, ascorbic acid, formic acid, phosphites, hypophosphites, dithiols, and mixtures thereof.

6. A composition according to claim 1, wherein the composition is substantially free of non-vaporizable organic stabilizing agents.

7. A precursor ink comprising a composition according to claim 1 and at least one polar solvent, wherein the composition is dispersed in the solvent thereby forming the precursor ink.

8. A method of preparing a composition comprising quaternary metal chalcogenide nanoparticles stabilized by an inorganic metal-chalcogenide stabilizing agent, wherein the method comprises:
(a) providing a first polar solution comprising a metal-chalcogenide complex;
(b) adding a first metal salt to the first polar solution to form a second polar solution; and
(c) reacting a second metal salt with the second polar solution;
thereby forming a polar dispersion of quaternary metal chalcogenide nanoparticles stabilized by an inorganic metal-chalcogenide stabilizing agent.

9. A method according to claim 8, wherein the first metal salt comprises metal salts of Zn(II), the second metal salt comprises metal salts of Cu(I) or Cu(II), and the quaternary metal chalcogenide nanoparticles substantially comprise CZTS nanoparticles.

10. A method according to claim 9, wherein the first metal salt and the second metal salt are nitrate metal salts.

11. A method according to claim 8, wherein the inorganic metal-chalcogenide stabilizing agent is selected from the group consisting of: [Sn₂S₆]⁴⁻, [SnS₄]⁴⁻, [Sn₂S₃]²⁻, [Sn₂S₇]⁶⁻, [Sn₄S_{11]}⁶⁻, [Sn₃S₇]²⁻, [SnS₂]²⁻, [Sn₄S₁₅]¹⁶⁻, [SnS₃]²⁻, [Sn₂S₅]²⁻, and mixtures thereof.

12. A method according to claim 8, wherein the first solution includes a reducing agent, wherein the reducing agent decomposes and/or vaporize at temperatures of less than about 220° C.

13. A method according to claim 12, wherein the reducing agent is selected from the group consisting of: thiourea, thiourea derivatives, selenourea, selenourea derivatives, diborane, ascorbic acid, formic acid, phosphites, hypophosphites, dithiols, and mixtures thereof.

14. A method according to claim 12, wherein the molar ratio of the reducing agent to the second metal salt is greater than 1.2.

15. A method according to claim 8, wherein the polar dispersion of nanoparticles is substantially free of non-vaporizable organic stabilizing agents.

16. A method according to claim 8, wherein the reaction is conducted at a temperature of about 40° C.

17. A coated substrate comprising:
a) a substrate; and
b) at least one layer deposited on the substrate comprising a precursor ink according to claim 7.

18. A thin film comprising a coated substrate according to claim 17, wherein the layer comprises substantially annealed nanoparticles, wherein the molar ratio of metal and chalcogenide elements in the thin film is substantially similar to the molar ratio of metal and chalcogenide elements of the nanoparticles in the precursor ink.

19. A method of preparing a thin film, wherein the method comprises heating a coated substrate according to claim 17 to a temperature of about 180-250° C. to form the annealed thin film.

20. A method according to claim 19, wherein the annealing is carried out in the absence of a chalcogen vapor source.
